(19) United States
(12) Patent Application Publication
(10) Pub. No.: US 2006/0228606 A1
(43) Pub. Date: Oct. 12, 2006

(54) Water management in monopolar fuel cells

(76) Inventors: Brad N. Fiebig, Bryan, TX (US); Alan J. Cisar, Cypress, TX (US); Oliver J. Murphy, Bryan, TX (US); Daniel F. Houy, Caldwell, TX (US); Nicole L. Williams, Portland, OR (US)

Correspondence Address: STREETS & STEELE, 13831 NORTHWEST FREEWAY, SUITE 355, HOUSTON, TX, 77040, US

(21) Appl. No.: 11/388,219

(22) Filed: Mar. 23, 2006

Related U.S. Application Data
(60) Provisional application No. 60/664,514, filed on Mar. 23, 2005.

(51) Int. Cl. H01M 8/24; H01M 8/10; H01M 4/94

(52) U.S. Cl. 429/32; 429/34; 429/44; 429/13

(57) ABSTRACT

A monopolar fuel cell stack comprising proton exchange membrane fuel cells supplied with a gaseous anodic reactant, preferably hydrogen, and a gaseous cathodic reactant, preferably air. The monopolar fuel cell stack, forming at least one substantially planar array, includes a liquid water retention barrier disposed over an electrode to retain liquid water within the fuel cells. The barrier is preferably used over the cathode side of each fuel cell and allows excess air flow to cool the fuel cell stack without drying the membrane in each fuel cell. The liquid water retention barrier may be either: (i) a thin, gas permeable, liquid water impermeable membrane; (ii) a thin, porous sheet of material; or (iii) a thin, substantially solid sheet of material except for a plurality of small through-holes that penetrate from one side of the sheet to an opposing side of the same sheet.

This application claims priority to U.S. Provisional Patent Application Ser. No. 60/664,514, filed on Mar. 23, 2005.

### BACKGROUND OF THE INVENTION

1. Field of the Invention

The present invention relates to monopolar fuel cells and monopolar fuel cell stacks supplied with gaseous reactants, preferably with an oxidizing gas (oxidant) and a reducing gas (reductant), and the operation of such fuel cells.

2. Background of the Related Art

Fuel cells are a type of electrochemical cell that produces electrical energy as a result of electrochemically combining chemical reactants, commonly referred to as a fuel and an oxidant, within the fuel cells and producing at least one chemical product as well as releasing thermal energy. In a fuel cell, electrical energy is produced due to electrochemical oxidation reactions and electrochemical reduction reactions taking place within the fuel cell. A fuel cell can use hydrogen gas as a fuel (or reductant) along with oxygen gas or air as an oxidant which will be transformed electrochemically within the fuel cell to produce electrical energy along with water so long as the fuel and oxidant are supplied to the fuel cell. The water thus produced is commonly referred to as “product water”.

Other chemical oxidants (besides oxygen or air) and chemical reductants (besides hydrogen) can be used in fuel cells. For instance, typical chemical reductants (or fuels) would include methanol, ethanol, formic acid, dimethyl ether, hydrazine, and ammonia, while typical chemical oxidants would include hydrogen peroxide, nitric acid, chlorine, and bromine. However, the most suitable fuel for fuel cells is hydrogen gas, preferably pure hydrogen gas. Suitable sources of pure hydrogen gas include compressed hydrogen gas in high pressure cylinders, hydrogen gas stored within the lattice of suitably contained metal alloys (known in the art as metal hydrides), and hydrogen contained in chemical hydrides, such as sodium borohydride, lithium hydride, calcium hydride, etc. Hydrogen gas can be released from chemical hydrides on carrying out either hydrolysis or thermolysis processes. An advantage of the hydrolysis process is that the hydrogen released from chemical hydrides is humidified as it is produced.

In order to function, the fuel cell comprises an anode and a cathode, separated by an electrolyte. The electrolyte can consist of an ionically conducting aqueous solution, such as, aqueous potassium hydroxide, or aqueous sulfuric acid. However, it is more convenient if the electrolyte is in the form of an ion exchange membrane, either a cation exchange membrane or an anion exchange membrane. Ion exchange membranes can be in the form of thin, flexible organic polymer materials or thin, rigid ceramic materials. Typically, organic polymer cation exchange membrane materials can be homogeneous polymers as represented by the Nafion® family made by DuPont of Wilmington, Del., or polymer composites comprising a support matrix impregnated with the cation exchange polymer material as represented by the Gore Select® family of membranes made by W.L. Gore & Associates, Elkington, Md. Ion exchange polymer membranes used in fuel cells typically have thicknesses in the range of 20-200 micrometers. An attractive form of a cation exchange membrane as a solid polymer electrolyte for use in fuel cells is a proton (H⁺) exchange membrane (PEM). Similarly, an attractive form of an anion exchange membrane as a solid electrolyte for fuel cells includes hydroxyl ion (OH⁻) exchange membranes (HIEM) and oxide ion (O²⁻) exchange membranes (OIEM). As is well known to one skilled in the art, “ion exchange membranes,” “cation exchange membranes,” and “anion exchange membranes” are also referred to as “ion conducting membranes,” “cation conducting membranes” and “anion conducting membranes,” respectively.

In general, thin, flexible organic polymer ion exchange membranes used as solid polymer electrolytes in fuel cells are limited to operating temperatures of less than 100° C. at pressures close to atmospheric pressure since ion conduction through these membranes requires that the membranes be at least partially saturated with water in the liquid phase. Thus, in order for Nafion®-like proton exchange membranes to conduct protons from the anode, through the thickness of a proton exchange membrane to the cathode, it is necessary for such membranes to be wet with liquid water. This water has been provided from various sources in the past, including humidification of the anode reactant gas, humidification of the cathode reactant gas, and by back diffusion of liquid water if produced at the cathode, through the proton exchange membrane towards the anode.

During operation of a fuel cell supplied with gaseous reactants, e.g., hydrogen gas as the fuel at the anode and oxygen gas (or air) as the oxidant at the cathode, organic polymer proton exchange membranes can become sufficiently dehydrated either at the anode electrocatalyst/membrane interface, the cathode electrocatalyst/membrane interface, or throughout the bulk thickness of the membrane such that cell performance can be greatly reduced and degradation or decomposition of the membrane takes place. Dehydration of a membrane can occur almost uniformly over the electrochemically active plane of the membrane or in localized regions of the active plane. One mechanism that leads to drying of a proton exchange membrane is referred to as electroosmotic drag. As protons pass from the anode to the cathode through the proton exchange membrane each proton drags water molecules surrounding the proton, or within its hydration sheath, with it towards the cathode. Accordingly, this drying effect occurs throughout operation of a fuel cell that is supplied with gaseous reactants. Furthermore, this drying effect is relatively proportional to the current density experienced by the fuel cell during operation of such devices. The dehydrating effects due to this mechanism of drying have the greatest impact on the performance of a fuel cell at the anode electrocatalyst/membrane interface.

A second mechanism of drying a proton exchange membrane solid polymer electrolyte in a fuel cell is associated with the characteristics of the anode reactant gas and cathode reactant gas utilized by the cell. If these reactant gases are not almost fully humidified at the operating temperatures and pressures of the fuel cell, the membrane can dry out at either the anode electrocatalyst/membrane interface, the cathode electrocatalyst/membrane interface, or at both electrocatalyst/membrane interfaces. The dehydrating effects as a result of this mechanism will be more pronounced the greater the flow rate of the dry, or partially humidified, reactant gases supplied to the fuel cell. Furthermore, membrane drying effects arising from this mechanism will tend to be non-uniform in the plane of the membrane and will be more pronounced at the points of introduction of the reactant gas(es) into or across the fuel cell. Therefore, the extent of drying of a proton exchange membrane in the fuel cell depends upon various factors, including the physical design, or structure, of the cell and the operating conditions in which the cell is used.

While the PEM, or at least the anode electrocatalyst/membrane interface, is subject to drying the cathode electrocatalyst/membrane interface can be the subject of flooding. Flooding is a term used to describe the situation when liquid water covers reaction sites on the electrocatalyst layer, and/or saturates the gas diffusion layer in contact with the electrocatalyst layer, such that most of a reactant gas is blocked from accessing the electrocatalyst sites. The flooding of the cathode in the fuel cell is affected by several factors, including the rate of water generation at the cathode, the rate of electroosmotic water transfer from the anode through the proton exchange membrane to the cathode, and the operating conditions of the fuel cell including temperature, pressure, reactant gas stoichiometry, and the humidity of the reactant gas.

Fuel cells can be designed to facilitate electrochemical reactions taking place at fast rates utilizing gaseous reactants, e.g., hydrogen gas and oxygen gas (or air), to produce electrical energy and product water. However, in some instances, such as to achieve fast reaction rates, it has been found to be advantageous to externally humidify the reactant hydrogen gas and/or reactant oxygen gas (or air), prior to separately introducing them to a fuel cell. Depending on the operating temperature and pressure of a fuel cell, the product water formed can primarily be in the liquid phase or in the vapor phase. A proton exchange membrane fuel cell includes an anode and a cathode in intimate contact with opposing sides of a proton exchange membrane. During operation of such a fuel cell, the anode electrocatalyst layer transforms hydrogen gas molecules into electrons and protons. The electrons are collected by means of a current collector in contact with the anode electrocatalyst layer and are passed through an external circuit that is connected to the cathode current collector. The protons formed by the anodic reaction at the anode electrocatalyst/proton exchange membrane interface pass through the proton conducting membrane solid electrolyte from the anode to the cathode. Protons and electrons delivered to the cathode electrocatalyst layer along with oxygen gas molecules (or air) delivered over the face of the cathode react to form product water at the cathode electrocatalyst/proton exchange membrane interface. In this manner, the fuel cell is used to produce a useful electrical current in the external circuit and high purity product water.

During the operation of PEM fuel cells, it is essential that a proper water balance be maintained between a rate at which water is produced at the cathode electrode and rates at which water is removed from the cathode and at which water is supplied to the anode electrode. An operational limit on performance of a fuel cell is defined by an ability of the cell to maintain the water balance as electrical current drawn from the cell into the external load circuit varies and as an operating environment such as the surrounding temperature of the cell varies. For a PEM fuel cell, if insufficient water is returned to the anode electrode, adjacent portions of the PEM electrolyte dry out thereby decreasing the rate at which protons may be transferred through the PEM and also resulting in cross-over of the reducing fuel gas, which is typically hydrogen or a hydrogen rich gas, leading to local over heating. Thus, drying out or localized loss of water can ultimately result in the development of cracks and/or holes in a proton exchange membrane. These holes allow the mixing of the hydrogen and oxygen reactants, commonly called “cross over,” with a resultant chemical combustion of cross over reactants, loss of electrochemical energy efficiency, and localized heating. Such localized heating can further promote the loss of water from the proton exchange membrane and further drying out of the membrane, which can accelerate reactant cross over. Similarly, if insufficient water is removed from the cathode, the cathode electrode may become flooded effectively limiting oxidant supply to the cathode electrocatalyst and hence decreasing electronic current flow. Additionally, if too much water is removed from the cathode by the oxidant gas stream, the cathode may dry out limiting the ability of protons to pass through the PEM, thus decreasing cell performance.

Excess water is removed from the cathode of a monopolar fuel cell stack by evaporating the water into the oxidant gas stream. This approach has a disadvantage in that it requires that the oxidant gas surrounding the cathode be unsaturated and, preferably, have a low relative humidity, so that the product water (and any water dragged from the anode to the cathode) will evaporate into the unsaturated oxidant gas stream. However, monopolar fuel cell systems typically do not control the oxidant flow rate or humidity.

In a PEM fuel cell, or in a PEM fuel cell stack, that employs the aforesaid water removal approach, the flow rate of the oxidant gas stream must be sufficiently high to ensure that the oxidant gas surrounding the cathode does not become saturated with water vapor. Otherwise, saturation of the oxidant gas will prevent evaporation of the product and drag water and leave liquid water to accumulate within the cathode gas diffusion electrode. This liquid water will prevent access of oxidant gas to the active sites of the cathode electrocatalyst thereby causing an increase in cell polarization, i.e., mass transport polarization, and a decrease in fuel cell performance and efficiency. Another disadvantage with the removal of product and drag water by evaporation through the use of an unsaturated oxidant gas stream is that the proton conducting membrane itself may become dry under certain operating conditions.

As previously mentioned, two techniques for maintaining sufficient hydration at the anode electrocatalyst/membrane interface for a PEM fuel cell supplied with gaseous anodic and cathodic reactants include humidification of the fuel gas and back diffusion of product water from the cathode through the proton exchange membrane to the anode. Conversely, for PEM fuel cells there has been much attention given to discharging or removing water from the cathode either as liquid water or as water vapor. Cathode gas diffusion layers are made at least partly hydrophobic so as to expel liquid water from the cathode electrocatalyst/gas diffusion electrode interface to the gas diffusion electrode/flow field interface and to provide water unsaturated regions within the gas diffusion electrode in which the reactant gas can access the cathode electrocatalyst sites. One technique that has been used in order to withdraw water as water vapor involves flowing an excessive amount of a reactant gas over the back surface of the cathode gas diffusion layer. However, this technique has its drawbacks. For example, high reactant gas flow rates may require a significant consumption of energy, thereby reducing the overall efficiency of the fuel cell system. Still further, the complexity or efficiency of some fuel cell designs has not been optimized.

However, there is still a need for an improved monopolar fuel cell structure or design, where the fuel cell is supplied with hydrogen gas or a hydrogen-containing gas as a reductant and the fuel cell is suitable for satisfying in a passive manner, under a broad range of cell operating conditions one or more of the following requirements: (i) avoidance of drying out at the anode electrocatalyst/proton exchange membrane interface; (ii) avoidance of flooding at the cathode electrocatalyst/proton exchange membrane interface; (iii) maximizing the recovery of liquid water from the anode compartment of the fuel cell; and (iv) minimizing the evaporation of water from the cathode. It would be desirable if the fuel cell did not rely on external humidification of reactant gases or high reactant gas flow rates. It would be even more desirable to have a monopolar fuel cell structure or design that did not dry out under operating conditions of elevated temperature at atmospheric pressure or subatmospheric pressure at ambient temperatures and did not require active water management, active liquid water recovery systems, or active oxidant flow control.

### BRIEF DESCRIPTION OF THE DRAWINGS

FIG. 1(a)is a schematic cross-sectional side view of a segment of an air-breathing multicell monopolar planar array fuel cell stack.

FIG. 1(b) is a schematic cross-sectional side view of the fuel cell stack of FIG. 1(a) with a water retention barrier attached to each cathode.

FIG. 2(a)is a schematic cross-sectional side view of segments of two air-breathing multicell monopolar planar array fuel cell stacks placed back-to-back to one another so as to share a common hydrogen gas manifold or plenum.

FIG. 2(b)is a schematic cross-sectional side view of the fuel cell stacks of FIG. 2(a) with a water retention barrier attached to each cathode.

FIG. 2(c)is a schematic cross-sectional side view of the fuel cell stacks of FIG. 2(b) sharing a common air cooled heat transfer structure.

FIG. 3(a) is a perspective view of an air-breathing five-cell monopolar planar array fuel cell stack, such as the fuel cell of FIG. 1.

FIG. 3(b) is a perspective view of the fuel cell stack of FIG. 3(a) with a water retention barrier firmly attached around the perimeter of the stack and covering the air exposed cathode side of the stack

FIG. 3(c) is perspective view of the fuel cell stack of FIG. 3(a) with a water retention barrier not only firmly attached around the perimeter of the stack but also firmly attached around the perimeter of each individual fuel cell and covering the air exposed cathode side of the stack.

FIGS. 4(a)-(c) are diagrams illustrating various geometrical configurations for water retention barriers of the present invention.

FIGS. 5(a)-(g) are schematic cross-sectional side views of various configurations of gas diffusion layers suitable for incorporation in fuel cells of the type shown in FIGS. 1, 2, and 3.

FIG. 6 is a cross-sectional side view of a subassembly that includes a water retention barrier, an air filtration layer and a structural support member.

FIG. 7 represents polarization curves showing average cell potential as a function of current density.

FIG. 8 are graphs of cell voltage over time for one fuel cell with a porous liquid water retention barrier and one fuel cell without a porous liquid water retention barrier, both run at a constant current of 1.5 Amps while the ambient room temperature was raised from 25° C. to 42° C.

### DETAILED DESCRIPTION OF THE PREFERRED EMBODIMENTS

The present invention provides a monopolar fuel cell (or a monopolar fuel cell stack) supplied with a gaseous anodic reactant, preferably hydrogen, and a gaseous cathodic reactant, preferably air. The cell avoids drying out at the anode electrocatalyst/ion exchange membrane interface, avoids flooding at the cathode electrocatalyst/ion exchange membrane interface, facilitates recovery of liquid water from the fuel cell at the anode compartment, and at the same time hinders the vaporization of water from the cathode. The fuel cell includes an ion exchange membrane that is preferably a proton (H⁺) conducting membrane. The present invention reduces evaporative water losses from at least one of the electrodes by providing a water retention barrier covering the electrocatalyst/ion exchange membrane interface of the fuel cell at some position, such as between a gas diffusion electrode and a gas plenum or gas flowfield that provides a reactant gas supply. The water retention barrier may be either: (i) a thin, gas permeable, liquid water impermeable membrane; (ii) a thin, porous sheet of material; or (iii) a thin, substantially solid sheet of material except for a plurality of small through-holes that penetrate from one side of the sheet to an opposing side of the same sheet. Any one or any combination of these types of gas permeable or gas accessible barriers can be disposed between either the anode electrocatalyst and the anode reactant gas stream or the cathode electrocatalyst and the cathode reactant gas stream; however, the barriers are most advantageously used at the cathode side of the fuel cell.

In the case of a water retention barrier comprising a gas permeable, liquid water impermeable membrane, a particularly preferred membrane is a thin sheet of polytetrafluoroethylene (PTFE), such as having a thickness from 0.1 microns to 20 microns, more preferably from 0.3 to 5 microns, most preferably from 0.5 to 1 micron. These membranes are nonporous, but gas permeable. Other polymers, including fully fluorinated polymers, partially fluorinated polymers and other gas permeable polymers, that act as a membrane that is permeable to the relevant gases may also be used. It is anticipated that some polymer membranes might need to be supported on a macroporous or perforated material. If not made from a hydrophobic material, the membrane may be further coated preferably with a material which renders at least one surface of the membrane hydrophobic. A further benefit is that these membranes might exhibit some degree of selectivity to the passage of oxygen over nitrogen, argon, carbon dioxide or other gases that are part of, or suspended in, the air. Such selectivity might provide a fuel cell with additional performance benefits. A membrane that is selective to oxygen would also be expected to withhold water.

In the case of a water retention barrier comprising a porous sheet of material, such as a sheet of expanded polytetrafluoroethylene (PTFE), the pores may correspond to those classified as mesopores (average pore diameter between 2 nanometers and 50 nanometers) and/or macropores (average pore diameter greater than 50 nanometers) and have various pore densities per unit area of the sheet. The degree of porosity (or pore density) of the porous sheet of material will affect the performance of the fuel cell. A highly porous material readily facilitates the transport of a reactant gas to, or a product gas from, an electrocatalyst/ion exchange membrane interface, but also increases the loss of water due to evaporation. Conversely, a low porosity material aids in preventing the loss of water from the fuel cell due to evaporation, but impedes access of a reactant gas to an electrocatalyst/ion exchange membrane interface. The porous retention barriers of the present invention have an average pore size between 2 and 500 nanometers, such as between 20 and 200 nanometers and a thickness in the range 25 microns to 250 microns (0.001 inches to 0.010 inches). This range of pore sizes allows the barrier to be freely accessible or permeable to a reactant gas and/or product gas, such as oxygen, air, or other cathode reactive gases as well as water vapor. The porous sheet may comprise a woven or non-woven fibrous material, or may be formed from a plurality of fine individual fibers that have been compacted or sintered, or may be formed from one or more expanded sheets of a solid material. Still further, the porous sheet may be made from metal foam comprising open cells, perhaps crushed and/or impregnated with particulate and/or colloidal PTFE to obtain the desired pore size. Any of the porous sheets may be further coated, preferably with a material which renders at least one surface of the sheet hydrophobic.

In the case of a water retention barrier comprising a thin, substantially solid sheet of material, a plurality of small diameter through-holes extending from one surface to an opposing surface facilitate the transport of air (or oxygen) to an electrocatalyst/ion exchange membrane interface. The through-holes may be selected from one or more geometrical shapes including, without limitation, circular, square, rectangular, triangular, diamond, oval, pentagonal, hexagonal, or heptagonal. Still further, the sheet may consist of a metal foil etched to produce a porous sheet. Alternatively, the through-holes may be in the form of slots or slits. The preferred size of the through-holes and the number of the through-holes per unit area of the solid sheet will be determined on the one hand by the need to maintain an adequate supply of air (or oxygen) to the electrocatalyst/ion exchange membrane interface and on the other hand by the requirement to maintain water in the fuel cell, in particular water within the ion exchange membrane. To satisfy these demands of the fuel cell, the total area associated with the through-holes will normally be in the range of 1% to 20% of the geometric area of the solid sheet, where the geometric area of the solid sheet corresponds to the geometric area of an electrode in the fuel cell. The substantially solid sheet can be either rigid or flexible and may optionally have a thickness in the range of 25 microns to 250 microns (0.001 inches to 0.010 inches), but it could be much thicker. Advantageously, some or all of the surface (optionally including the walls of the through-holes) of the substantially solid sheet water retention barrier that is adjacent the cathode electrode (or the anode electrode as the case maybe) is preferably coated or treated so that it is made hydrophobic. Such a treatment may involve brushing or spraying with a halogenated polymer solution to give a thin film of the dried or cured polymer material on the surface. Where the barrier is a metal sheet with through-holes or metal foam comprising open cells, the barrier may be coated with quasicrystals, such as through a process of electrocodeposition as described in copending U.S. patent application Ser. No. 10/824,183, which is incorporated by reference herein, in order to make the barrier highly hydrophobic and to reduce the pore size.

All fuel cells that utilize proton exchange membranes as solid polymer electrolytes produce product water at their cathodes as shown by equation 2, below. In addition to the product water produced at the cathode, more water is delivered to the cathode by the electroosmotic drag of the protons that are transported through the thickness of the membrane from the anode to the cathode. However, in a fuel cell supplied with hydrogen gas as fuel and oxygen gas (or air, or oxygen-enriched air as the source of oxygen) as the oxidant, the transfer of water by electroosmotic drag from the anode to the cathode is typically balanced by the Fickian diffusion of water from the cathode to the anode. This is the case particularly for fuel cells that use relatively thin (e.g., 10-50 μm) proton exchange membranes as solid polymer electrolytes. There is essentially no net water transfer from the anode to the cathode and, in the absence of excessive evaporation, the hygroscopic proton exchange membrane retains sufficient water to maintain high proton conductivity.
H₂→2 H⁺+2e⁻(Anode Reaction) Equation 1
2 H⁺+½O₂+2e⁻→H₂O (Product Water) (Cathode Reaction) Equation 2

The electrolyte between the anode and the cathode may be an acidic solution, phosphoric acid, sulfuric acid, an aqueous solution, an alkaline solution, a solution of potassium hydroxide, a polymer with sulfonic acid functionalities or other acid functionalities. An exemplary polymer electrolyte has sulfonic acid functionalities that may be partially or fully halogenated, such as with fluorine.

While the liquid water retention barrier of the present invention does allow water vapor to pass through it, the barrier restricts the volume or amount of water vapor drawn into the bulk of the gases outside the electrode structure, such as (a) the reactant gas as it passes through a gas plenum or a fuel cell flow field in contact with the barrier (typically at the anode), (b) the reactant gas as it passes over the barrier if the barrier is completely exposed to the reactant gas, e.g., as in an air-breathing monopolar fuel cell stack, or (c) the product gas that is being exhausted out of the cell. This barrier facilitates more water remaining in contact with the proton exchange membrane to improve membrane conductivity, hence, minimizing heat generation within the fuel cell. Lowering the amount of heat generated within the fuel cell maintains a greater fraction of the product water and/or electroosmotic water in the liquid phase at any given operating pressure. In turn, a larger amount of water at the cathode in the liquid phase gives rise to enhanced back diffusion of water from the cathode, through the proton exchange membrane to the anode. In addition, transferring water to the anode gas stream makes it possible to recover excess water from the anode for use elsewhere in the fuel cell stack or even outside the stack. In general, it is simpler to recover water from the anode compartment at all times, than from an oxidant stream comprised of air, which is typically drawn from, and released to, the environment.

The liquid water retention barrier of the present invention can take various positions within the fuel cell. For example, the barrier may be disposed between a flow field and a gas diffusion electrode, within a gas diffusion electrode, or between the gas diffusion electrode and the adjacent electrocatalyst layer on one side of a proton exchange membrane. Regardless of the exact positioning of the barrier within the layered structure of the fuel cell, the barrier should cover most, if not all, of the electrochemically active surface area of an electrode. The liquid water retention barrier may be either completely electronically conductive, have some regions which are electronically conductive and other regions which are electronically non-conductive, or be completely electronically non-conductive (electronically insulating). Whether or not the barrier must be electronically conductive depends on where the barrier is located or positioned relative to the electronic current path. If the barrier (or a portion of the barrier) is in a location that would normally be in the electronic current path, then it will generally be electronically conductive or allow electronically conductive elements to extend there through. If the barrier is in a location not normally in the current path it will generally be electronically non-conductive. While the retention barrier may find suitable use in, or attached to, the anode compartment, it is generally preferred to use the barrier in relation to the cathode and not the anode. The cathode side of the fuel cell presents the best opportunity to retain water within a monopolar fuel cell containing a proton exchange membrane, because product water is produced at the cathode and electroosmotic water is delivered to the cathode. By retaining liquid water within the cell there is less need for make-up water and/or humidification of the reactant gas streams. Still, depending on the physical and/or chemical characteristics of the barrier it may allow sufficient water vapor losses to avoid flooding of the cathode. In addition, the physical and/or chemical characteristics of the barrier are sufficient to avoid restricting the flow of oxygen (or air) to the cathode to support the cathode reactions. Still further, use of the liquid water retention barrier is particularly advantageous at the cathode of a monopolar fuel cell, because the operating conditions, such as the oxidant flow rate and humidity, at the cathodes of this type of cell or cell stack are generally not controlled.

The liquid water retention barrier maybe made from any suitable material including, without limitation, a porous thermoplastic, other porous polymer sheet or film, expanded PTFE, other expanded polymer sheet or film, filter paper, perforated polymer film, perforated metal sheet or foil, etched metal sheet or foil, micro expanded metal sheet or foil, porous sintered metal frits, metal felts, metal foams comprising open cells, porous metal oxide sheet such as aluminum oxide, polymer felts, polymer foams comprising open cells, carbon aerogels, resorcinol-formaldehyde aerogels, porous ceramic frits, ceramic felts, or perforated ceramic sheet, other similar materials, or combinations thereof. Non-halogenated thermoplastics useful in this invention include, but are not limited to, polyethylene, polypropylene, polystyrene, polycyclopentadiene, polyester, polycarbonate, polyethersulfone, polyimides, the various nylons, other similar compounds, and combinations thereof. Halogenated thermoplastics useful in this invention include polytetrafluoroethylene (PTFE), polyvinylidene fluoride (PvDF), polyvinylflouride (PVF), polyvinylchloride (PVC), other similar compounds, and combinations thereof. These and other polymers may be used alone, in combination with each other, or in combination with other modifiers, such as carbon or powdered metal, to produce composites with special properties, such as electronic conductivity, stiffness, rigidity, flexibility, etc. Metal composites, or composites of metals with nonmetals such as oxides, may also be used and may be especially useful when some combination of desirable properties can be obtained form the blend that cannot be obtained from any of its pure components. Other compositions useful for forming the barriers of this invention will be apparent to those skilled in the art after gaining an understanding of the present invention.

In the case of a water retention barrier comprising a porous sheet of material, the preferred full average pore size in the liquid water retention barrier is between 20 and 500 nanometers, more particularly between 50 and 500 nanometers, and most preferably between 100 and 500 nanometers. Optionally, perforations may be formed by etching, laser drilling, and other methods available to those skilled in the art.

The liquid water retention barrier may be made more resistant to liquid water transmission by coating the retention barrier, for example making the barrier hydrophobic. Hydrophobic pores resist water blockage. The barrier may be made hydrophobic through the use of inherently hydrophobic materials to fabricate the barrier or by partially or fully coating the barrier with a hydrophobic material, such as partially or fully fluorinated polymers including PTFE or certain hydrocarbon-based polymers, or by electrocodeposition of a layer comprising quasicrystals. The barrier can be fabricated by adding a modifier, such as PTFE or PvDF, to modify the pore structure, such as with the pore structure of polymer foam or a metal foam comprising open cells. Other suitable liquid water retention barriers include thin sheets of microporous polypropylene (such as CELGARD®) and other separators known for use in batteries. A liquid water retention barrier may be made in any suitable thickness, but is preferably between 10 and 500 micrometers (0.4 and 20 mils or 0.0004 and 0.020 inches) in thickness. A solid gas permeable barrier or membrane may need to be as thin as 0.1 micrometer. In one embodiment, the liquid water retention barrier is prepared from a liquid dispersion that forms a porous layer upon evaporating, curing, sintering or solidifying. Still further, the liquid water retention barrier may be a composite structure, such as an organic/inorganic composite including organic/metallic and metallic/oxide composites.

In one embodiment of this invention, the liquid water retention barrier is produced from a material (pure phase or composite) that has high elasticity and flexibility and a coefficient of thermal expansion that is at least 30% different from the adjacent structural materials in the stack. For example, the barrier might be prepared with a thermoresponsive polymer hydro gel composed of poly(vinyl alcohol) and poly(acrylic acid). If the barrier is physically constrained (such as by adhering the barrier to an electrode structure) and expands more on heating than the rest of the stack, then the result will be a barrier with pores that become smaller at higher temperatures, thereby impeding water losses through evaporation. If the barrier is physically constrained and expands less on heating than the rest of the stack, then the pores will become larger at higher temperatures, thereby promoting increased gas exchange and water vapor losses. In another embodiment of this invention, the pores in the barrier are lined with a polymer that changes its hydrophobicity with temperature. Examples of this type of material are described in U.S. Pat. No. 6,699,611, which patent is incorporated by reference herein. These embodiments regulate the flow of moisture away from the electrode by making the barrier more resistant to the passage of water as the temperature rises (a negative thermo-responsive polymer).

One particular advantage of using the water retention barrier of the present invention is that a high air flow rate may be used without resulting in drying of the cathode. A large excess of air is useful for cooling the stack, but too much air can result in drying out of the cathode. This is often the case with an array of monopolar fuel cells, which may provide no control of the air flow rate over the cathodes. The liquid water retention barrier of the present invention allows a monopolar fuel cell stack to take full advantage of excess air flow without suffering the full extent of drying at the cathodes that would typically occur.

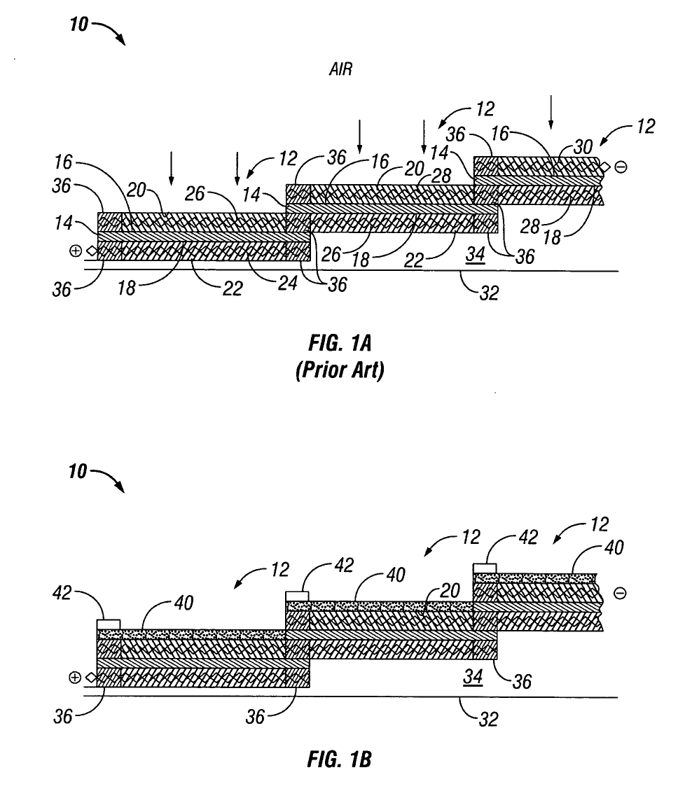

The monopolar fuel cell stacks of the present invention include an ion conducting membrane, an anode electrocatalyst layer, a cathode electrocatalyst layer, and typically a pair of gas diffusion layers disposed over the anode electrocatalyst layer and the cathode electrocatalyst layer. Suitable ion conducting membranes, such as proton exchange membranes, are well known to one skilled in the art and include NAFION® (a trademark of Dupont of Wilmington, Del.) which is a perfluorinated sulfonic acid polymer. The anode and cathode electrodes typically comprise an electrocatalyst layer or thin film applied to either surface of the proton exchange membrane. Such electrocatalysts typically include platinum, ruthenium, other precious metals or alloys including these metals. The catalyst can be used neat, in the form of a powder or metal black, or supported on another material, preferably a conductive material. Regardless of the form that the catalyst is in, it is generally compounded with a binder to keep it in the desired position. Examples of gas diffusion layers include waterproofed porous carbon paper, electronically conductive carbon felts, carbon cloth impregnated with carbon powder and/or carbon fibers, expanded metal sheets impregnated with carbon powder and/or carbon fibers, woven and non-woven metal cloths impregnated with carbon powder and/or carbon fibers, and metal foams comprising open cells impregnated with carbon powder and/or carbon fibers. Any or all these layers may include further treatments, coatings, modifiers, or configurations that assist in their operation. For example, the electrocatalyst layer may be mixed with certain amounts of perfluorinated sulfonic acid polymer solutions to enhance proton conductivity and the carbon powder and/or carbon fibers included in the gas diffusion layer may be mixed with polytetrafluoroethylene to make regions of the gas diffusion layer hydrophobic. Individual fuel cells in a monopolar fuel cell stack are typically arranged edge-to-edge with an electronically conducting member extending between the cathode and anode of adjacent cells. (See FIG. 1.)

For monopolar fuel cell stacks that incorporate one or more embodiments of this invention, a gas diffusion electrode is made by mixing Vulcan XC-72R high surface area carbon powder (available from CABOT Technology Division, Pampa, Tex.) with polytetrafluoroethylene “PTFE” suspension (such as T-30, available from DuPont, Wilmington Del.) in a range of 45-70 weight percent carbon powder and 30-55 weight percent polytetrafluoroethylene (based on the dry weight of the PTFE), water, and a nonionic surfactant (such as Triton X 100, available from Fisher Scientific, Fair Lawn, N.J.). The carbon/PTFE mixture is sonicated to reach complete dispersion and the resulting paste is spread onto a fluid permeable metal support/current collector, such as, an expanded metal foil, perforated or etched metal sheet, metal foam having open cells, or woven or non-woven metal wire cloth.

The fluid permeable metal support/current collector may be selected from titanium, nickel, copper, stainless steels, tin and tin alloys including copper-tin alloys, aluminum and aluminum alloys, or magnesium and magnesium allows. Before being coated with the paste comprising the gas diffusion electrode matrix, a suitable fluid permeable metal support/current collector may be coated with a layer of a metal, metal oxide, metal nitride, or metal carbide to protect it from corrosion and/or oxidation phenomena under the operating conditions of an electrochemical cell stack. Electrodeposition, chemical vapor deposition or sputtering are suitable processes for applying a layer of metal, metal oxide, metal nitride, or metal carbide to a metal support/current collector. The metal forming the coating can be selected from tin and tin alloys, silver and silver alloys, copper and copper alloys, gold and gold alloys, or bismuth. Suitable metal oxides include tin oxide (preferably doped with indium or fluorine), 30 mole % ruthenium dioxide/70 mole % titanium dioxide, and the mixed suboxides of titanium, e.g., Ti₂O₃, Ti₃O₅, Ti₄O₇, Ti₅O₉, etc. Metal nitrides for this application would include titanium nitride and molybdenum nitride and examples of metal carbides are titanium carbide and tungsten carbide. For some fuel cell applications it may be more suitable to convert the outer layers of a metal support/current collector (or a coated metal support/current collector) to the corresponding metal oxide (or mixed metal oxides) by heating the metal support/current collector in air (or oxygen) at a temperature in the range of 300° C. to 800° C. for a time in the range of 0.5 hours to 5 hours.

Alternatively, the gas diffusion electrode can be made by mixing Vulcan XC-72R high surface area carbon powder (CABOT) and carbon fibers (such as Thornel™ DKD-X manufactured by Amoco Corp., Apharetta, Ga.) with PTFE suspension (T-30, DuPont), in a range of 45-55 weight percent carbon powder, 13-21 weight percent carbon fibers and 25-35 weight percent polytetrafluoroethylene ratio (based on the dry weight of the PTFE), water, and nonionic surfactant (Triton X 100). Again, the carbon/PTFE mixture is sonicated and the resulting paste is pasted onto an appropriate metal support/current collector as described above.

For monopolar fuel cell stacks where the current passing through each cell in the stack is collected from at least one edge of a cathode electrode of a first cell and from at least one edge of an anode electrode of an adjacent cell, then a fluid permeable metallic based support/current collector is highly desirable and preferred. A sintered mass derived from fine carbon powder (or a mixture of carbon powder and carbon fibers) and polytetrafluoroethylene emulsion is bonded onto and/or impregnated into the support/current collector. If desired, an electrocatalyst layer comprising an ion exchange polymer electrolyte can be applied to one surface of the resulting gas diffusion electrode. The support/current collector and the impregnated and/or bonded sintered mass comprise a unitary structure.

Contacts formed between the surfaces of carbon powder particles and/or carbon fibers create a plurality of three dimensional hydrophilic pathways throughout the bulk of the pressed and sintered mass comprising a microporous gas diffusion electrode. The tortuous hydrophilic pathways extend from a first surface to an opposite and substantially parallel surface of the sheet-like electrode. The hydrophilic pathways allow liquid water to be transported to, or away from, an ion exchange membrane/electrocatalyst interface in a fuel cell. Similarly, contacts formed between the surfaces of sintered polytetrafluoroethylene particles throughout the bulk of the pressed and sintered mass comprising a gas diffusion electrode create a plurality of three dimensional hydrophobic pathways that extend from the first surface to the opposite and substantially parallel surface of the sheet-like electrode. The tortuous hydrophobic pathways allow gases or vapors to be transported to, or away from, an ion exchange membrane/electrocatalyst interface in a fuel cell. The hydrophilic pathways and the hydrophobic pathways can be randomly, or uniformly, distributed throughout the bulk of the microporous gas diffusion layer forming three dimensional networks.

The hydrophilic and hydrophobic pathways facilitate two phase (gas and liquid) flow to (or away from) an electrocatalyst/ion exchange membrane interface. An optimum gas diffusion electrode structure and formulation provides a high activity or concentration of a reactant gas at an electrocatalyst/electrolyte interface even under high current density conditions (greater than 1 Acm⁻²) and where significant amounts of product water are formed such as when oxygen gas (or air) is reduced to liquid water in a fuel cell. Transport of such product water by wicking action through the network of hydrophilic channels prevents saturation of the gas diffusion layer with liquid water. A gas diffusion structure having a substantially homogeneous distribution of hydrophobic and hydrophilic pathways is deemed important to facilitating liquid water transport through the diffusion structure in both directions, i.e., toward and away from the cathode electrocatalyst layer, depending upon the operating conditions of the stack. This produces a stack that functions well across a range of operating conditions, such as a range of current densities where the degree of water production and electroosmotic flow may vary considerably. Furthermore, air cooling of the stack by flowing excess air over the liquid water retention barriers, may induce condensation of water vapor on the water retention barriers. Having a gas diffusion structure with substantially uniform hydrophilic and hydrophobic pathways allows this condensed liquid water to flow back to the ion exchange membrane/electrocatalyst interface to hydrate the membrane. Accordingly, improved water management is achieved without compromising the electrical conductivity and gas diffusion properties of the gas diffusion structure.

The liquid water retention barriers of the present invention may be either electronically conducting or electronically non-conducting (electronically insulating). While either an electronically conducting barrier or an electronically non-conducting barrier may be used in a monopolar fuel cell stack, there may be a need for accommodation in order to prevent short circuiting of adjacent cells. Furthermore, the barriers may include electronically conducting regions and electronically nonconducting regions in various patterns.

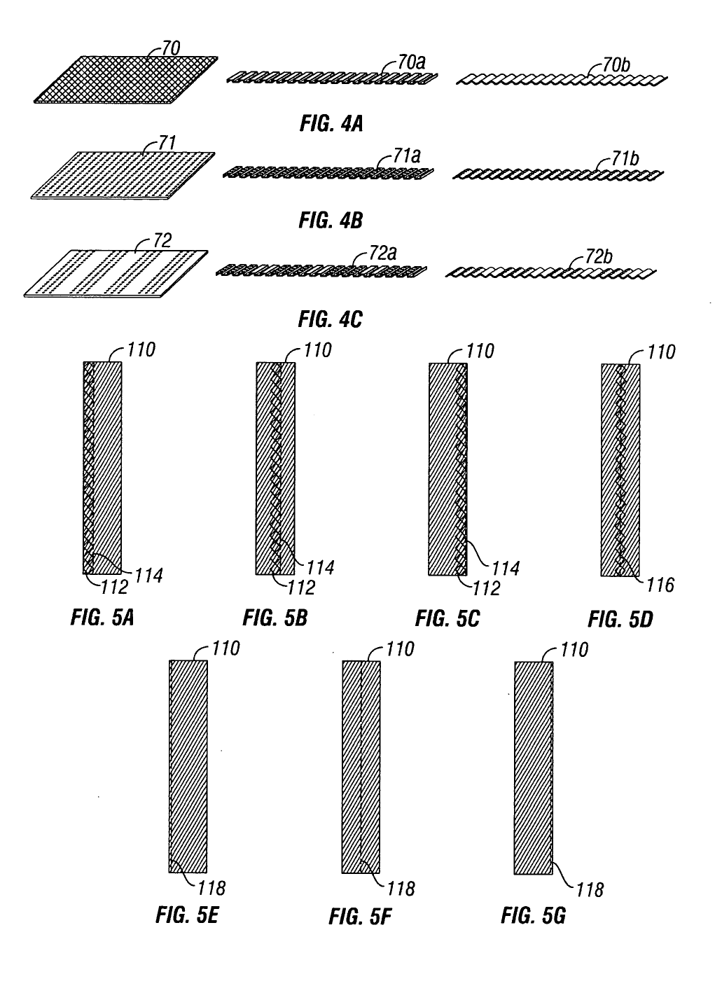

In one embodiment of the present invention, a porous, electronically conducting liquid water retention barrier is located at the back face of the gas diffusion structure (as shown in FIG. 5(c)). In this embodiment, the porous retention barrier, in the form of a metal or metal alloy sheet, metal foil or open cell metal foam, also serves as a key component of the current collector. A perforated metal, or metal alloy, barrier suitable for use in this embodiment is shown in FIG. 4(b). This figure also shows a barrier for use in a variation of this embodiment where a portion of the barrier is not perforated (as shown in FIG. 4(c)). The reactant gas permeable barrier can be used as the porous bare metal, or the surface of the barrier (including the walls of holes or pores) can be modified to either increase or decrease the hydrophobicity, but the modification preferably increases the hydrophobicity. Examples of appropriate materials for increasing hydrophobicity are PTFE, PvDF and quasicrystals. If it is desired for the surface to have less hydrophobicity (i.e., more hydrophilic character), other modifications, such as treating the metal to produce a conductive oxide layer may be appropriate.

For a monopolar fuel cell stack, a water retention barrier may be disposed in various places since it does not disrupt the electronically conducting pathways necessary for electrons to flow from one cell to an adjacent cell. For example, the water retention barrier may be disposed immediately adjacent the electrocatalyst layer (as shown in FIG. 5(e)), within a gas diffusion layer (as shown in FIG. 5(a), FIG. 5(b), FIG. 5(d), and FIG. 5(f)), or between the gas diffusion layer and a reactant gas stream (as shown in FIG. 5(c) and FIG. 5(g)). While other arrangements maybe possible, there is no essential need for a more sophisticated configuration.

It should be recognized that a current collector may be variously positioned, including adjacent to the cathode electrocatalyst layer, within the gas diffusion layer, or on the backside of the gas diffusion layer. In any of the foregoing configurations, it is generally preferred that the water retention barrier extend over the entire active area of the cell, even more preferably forming a seal with framing members to prevent the water vapor or gases from going around the barrier. However, the current collector must be positioned in electronic communication with the electrocatalyst layer. This electronic communication may be accomplished through direct contact with the electrocatalyst layer or contact with an electronically conducting gas diffusion layer that is itself in electronic communication with the electrocatalyst layer. The water retention barrier may be positioned on either side of the current collector, but if the water retention barrier is positioned between the electrocatalysts layer and the current collector then electronically conducting elements, either from the gas diffusion layer or the current collector itself, must extend through the water retention barrier in order to maintain electronic communication with the current collector.

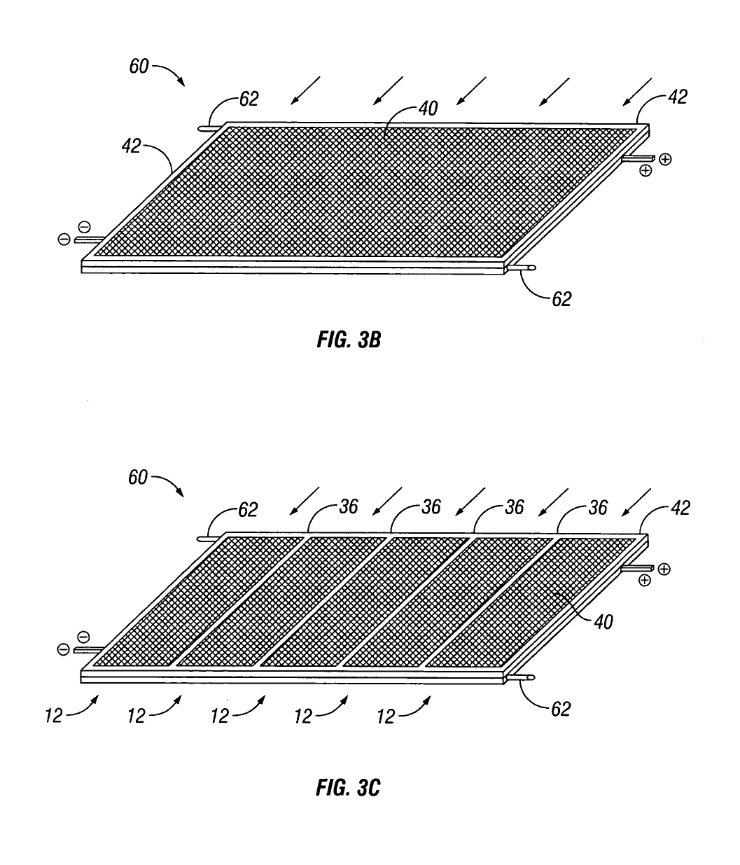

In a further embodiment, a monopolar fuel cell stack may receive an electronically non-conducting, liquid water retention barrier over one or more of the cells in the stack. While each cell may receive a separate water retention barrier, it is also possible to apply an electronically non-conducting barrier to a plurality of adjacent electrodes. So long as the water retention barrier is electronically non-conducting, this configuration does not produce a short circuit between the cells. The monopolar fuel cell stack arrangement typically has all of the cathodes directed along one face and in communication with an oxidant gas source. Similarly, a monopolar fuel cell stack typically has all the anodes on a common face and in communication with a fuel gas. Placing one electronically non-conducting water retention barrier over adjacent faces of a common electrode type, i.e., cathodes or anodes, has the advantages of simple construction and little or no reliance upon forming gas seals around each individual electrode. (See FIG. 3(b)).

Separately, a monopolar fuel cell stack could potentially use an electronically conductive liquid water retention barrier, but great care would have to be taken to avoid short-circuiting the cells. Accordingly, an electronically non-conducting water retention barrier is highly preferred for use with monopolar fuel cell stacks. Also, because monopolar fuel cell stacks typically do not control the air flow rate across the cathodes, a water retention barrier is particularly well suited for this application.

A liquid water retention barrier of the present invention maybe simply disposed adjacent or in intimate contact with an electrode, preferably a gas diffusion electrode, but a water retention barrier may also be secured to an electrode in a manner that avoids deformation of the barrier. For example, when liquid water or water vapor is inhibited from passing through a barrier, pressure may build up behind the barrier. Increased pressure and the accumulation of water may lead to a “bag effect” if the barrier is not suitably secured to the electrode structure. The barrier may be secured mechanically, but is preferably secured through adhesive bonding or hot pressing. Still further, the barrier may be formed within a gas diffusion layer.

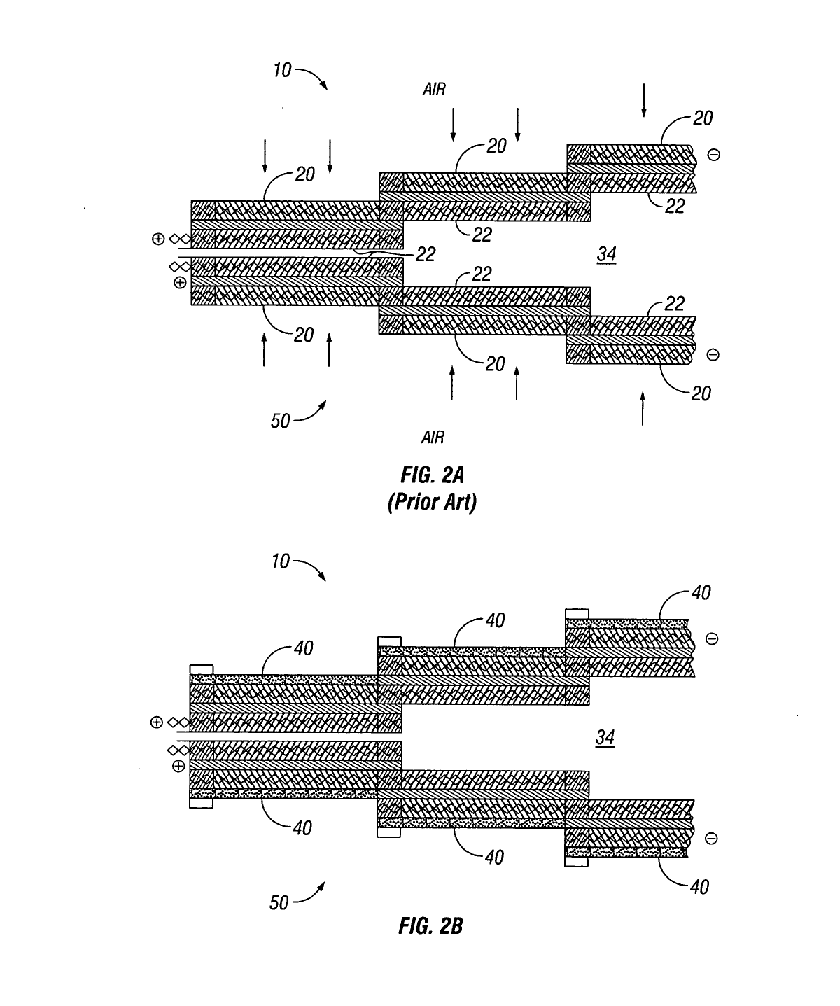

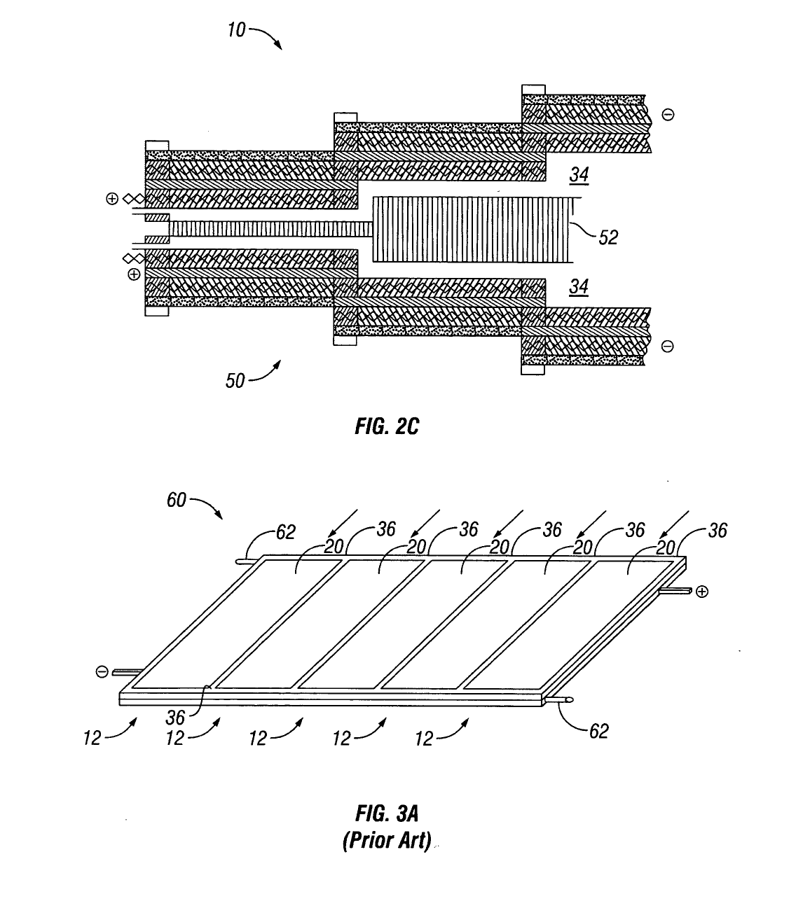

In still another embodiment of the present invention, a liquid water retention barrier is used to reduce the extent of water evaporation at the cathode while a surface parallel to the anode is simultaneously cooled. This configuration is illustrated in FIG. 2(c) for a monopolar fuel cell stack. This causes water condensation to occur at the cooled anode surface and lowers the vapor pressure in the anode compartment below saturation at the anode temperature. The condensate may be collected and removed from the fuel cell stack for further use. Under these conditions, the rate of water evaporation from the anode increases, which reduces the relative concentration of liquid water at the anode electrocatalyst/membrane interface. This depletion in turn increases the rate of liquid water diffusion from the liquid water rich cathode to the anode through the proton exchange membrane solid polymer electrolyte. The net result is the extraction and collection of the excess water produced electrochemically in the cell through the anode.

Liquid water collection at the anode of a monopolar fuel cell in a monopolar fuel cell stack can be accomplished by a variety of means. The water can be collected by wicks, which then carry the water out of the cell. Alternatively, the water can be pushed out of each cell in the fuel cell stack by the reductant gas flow which can be made to flow continuously or periodically, that is in a purging mode. Still further, the liquid water can settle to the bottom of the fuel cell stack by gravity for collection, in which case, the flow of liquid water can be promoted by the cooled anode surface being hydrophilic. On a hydrophilic surface, the water will rapidly spread out and move over the surface with less resistance to flow than on a hydrophobic surface. The surface can be made hydrophilic by proper choice of material or by modifying the surface itself. Potential methods for modifying the surface include oxidizing a metal surface or applying a hydrophilic coating to any type of surface. The recovered liquid water can be used for a variety of purposes including, but not limited to, supplying water to hydrolyze a hydrolysable chemical hydride to produce hydrogen gas to fuel the fuel cell.

All of the foregoing descriptions have dealt with the use of a liquid water retention barrier to maximize the retention of liquid water and to minimize or control losses of water vapor at the anode side, and/or the cathode side, but preferably at the cathode side, of a monopolar fuel cell, in particular a monopolar PEM fuel cell stack. However, the present invention is not limited to the retention of water. The invention disclosed here can also be usefully applied to improve the performance of any monopolar fuel cell stack by giving rise to passive control, management, or collection, as the case may be, of a volatile component, e.g., an electrolyte, or product. These monopolar fuel cell stacks include those stacks using an anion exchange membrane, an alkaline solution, or alkaline gel as an electrolyte, or any aqueous solution as an electrolyte.

Referring now to the specific details of the figures, FIG. 1(a) is a schematic cross-sectional side view of a segment of a prior art air-breathing multi-cell monopolar substantially planar array fuel cell stack 10. The monopolar substantially planar array fuel cell stack 10 has a plurality of cells 12 (only two and one-half cells are shown) connected in an electronic series circuit. Each of the cells 12 includes an ion conducting membrane 14, in this instance a proton exchange membrane (PEM), in contact with a cathodic electrocatalyst layer or film 16 and an anodic electrocatalyst layer or film 18. The cathodic and anodic electrocatalyst layers 16,18 are also in contact with cathodic and anodic gas diffusion layers 20,22, respectively, and are shown here with planar, fluid permeable current collector grids 24,26,28,30. These planar, fluid permeable current collector grids are electronically conducting and transport electrons from the anode of one cell to the cathode of an adjacent cell (as with current collector 26), to a cathode from an external circuit (as with current collector 30), and from an anode to the external circuit (as with current collector 24). The cathodic gas diffusion layers 20 are facing a source of oxygen, such as ambient air, as the oxidant. The anodic gas diffusion layers 22 are facing a source of fuel, such as hydrogen gas, as the reductant. The supply and distribution of a fuel is facilitated by attaching the stack on one of its sides to a base plate 32 in such a manner so as to give rise to a hydrogen gas plenum 34 (enclosed on the ends and sides) that supplies hydrogen gas to the anode of each individual fuel cell 12 in the array 10. In order to prevent mixing of the air and hydrogen gases, gas barriers or frames 36 are disposed around the perimeter of each individual cell 12. The gas barriers or frames 36 may also provide physical support and stability to the cells by securing the membranes, gas diffusion layers, and current collectors. Suitable monopolar fuel cells are described in U.S. Pat. Nos. 5,709,961; 6,054,228; 6,410,180; and 6,733,913; which patents are incorporated herein by reference.

FIG.1(b) is a schematic cross-sectional side view of the fuel cell stack 10 of FIG. 1(a) with a water retention barrier 40 attached to each cathode. The water retention barrier 40 is firmly attached around the perimeter of the stack and also around the perimeter of each individual fuel cell 12 and covering the air exposed cathode side of the stack. While the barrier 40 is shown here as a discrete element for each cell 12, it is also possible to lay a continuous barrier across all of the cells 12 in the stack 10. The barrier 40 may be physically secured with a rigid frame 42 or, more preferably, secured to the frames 36 with an adhesive. Still further, the barrier 40 may be secured with an adhesive across the entire area of contact with the electrode, such as along the surface of the gas diffusion layer 20.

FIG. 2(a) is a schematic cross-sectional side view of segments of two prior art air-breathing multi-cell monopolar substantially planar array fuel cell stacks 10,50 placed back-to-back to one another so as to share a common hydrogen gas manifold or plenum 34 (enclosed on the ends and sides). Integration of the two monopolar substantially planar array fuel cell stacks in this manner facilitates a common hydrogen gas plenum supplying hydrogen gas to the anode of each individual fuel cell in both arrays as well as electrically connecting, in a facile manner (not shown), the two fuel cell arrays in series to give a higher output voltage and power in a minimum volume package. The two stacks may be operated independently, connected and operated in series, or connected and operated in parallel.

FIG. 2(b) is a schematic cross-sectional side view of the fuel cell stacks 10,50 of FIG. 2(a) with a water retention barrier 40 attached to each cathode across the cathodic gas diffusion layer 20. The water retention barrier 40 is firmly attached around the perimeter of each stack and also around the perimeter of each individual fuel cell and covering the air exposed cathode side of each stack.

FIG. 2(c) is a schematic cross-sectional side view of the fuel cell stacks 10,50 of FIG. 2(b) sharing a common air cooled heat transfer structure 52. Integration of the two monopolar substantially planar array fuel cell stacks in this manner facilitates a common element for enhancing heat removal from the anode of each individual fuel cell 12 in both stacks. While the structure 52 extends between the two stacks 10,50 to facilitate cooling, the structure must not interfere with hydrogen delivery through the plenum 34 which is now bifurcated or otherwise no longer entirely open.

FIG. 3(a) is a perspective view of a prior art air-breathing five-cell monopolar substantially planar array fuel cell stack 60, consistent with the construction of fuel cell 10 of FIG. 1. Each of the cells are shown with a cathode gas diffusion layer 20 exposed for communication with air flowing over the surface. The anode gas diffusion layers are not shown in this figure, but are positioned on the opposing side of each cell and facing into a hydrogen gas plenum or chamber 34 (See FIG. 1 (a)) formed by a base plate disposed in a spaced apart manner adjacent the anode gas diffusion layers. Hydrogen gas may be provided to and from the plenum 34 through conduits 62.

The retention barrier also advantageously protects the gas diffusion layers from plugging up with particulates from the air including particulate matter from the exhausts of internal combustion engines, such as diesel engines. Such particulate matter may have particle sizes in the range of 0.1 to 100 microns. Furthermore, the retention barrier protects the gas diffusion layers from clogging up with suspended particulate matter, such as silt or vegetative matter, on immersing the fuel cell or fuel cell stack in a lake, river, or other source of non-potable water.

Attachment or adhesion across the faces of the gas diffusion layers themselves, prevents sagging of the liquid water retention barrier and assures that liquid water is maintained in close proximity to the PEM. Furthermore, having the water retention barrier in physical contact with the gas diffusion layer provides a continuous layer comprising continuous surfaces from the water retention barrier to the PEM so that the hydrophobicity of these surfaces can play a role in keeping liquid water near the PEM or driving liquid water back to the PEM.

FIG. 3(b) is a perspective view of the fuel cell stack 60 of FIG. 3(a) with a water retention barrier 40 firmly attached around the perimeter of the stack and covering the air exposed cathode side of the stack 60. The retention barrier 40 retains liquid water in the stack while allowing the passage of water vapor and other gases. The retention barrier also advantageously protects the gas diffusion layers from plugging up with particulates from the air including particulate matter from the exhausts of internal combustion engines, such as diesel engines. Such particulate matter may have particle sizes in the range of 0.1 to 100 microns. Furthermore, the retention barrier protects the gas diffusion layers from clogging up with suspended particulate matter, such as silt or vegetative matter, on immersing the fuel cell stack in a lake, river, or other source of non-potable water.

FIG. 3(c) is perspective view of the fuel cell stack of FIG. 3(b) with the water retention barrier 40 not only firmly attached around the perimeter of the stack 60, but also firmly attached around the perimeter of each individual fuel cell 12 and covering the air exposed cathode side of the stack. The additional attachment around the perimeter of each individual fuel cell, as well as the optional attachment or adhesion across the faces of the gas diffusion layers themselves, prevents sagging of the retention barrier and assures that liquid water is maintained in close proximity to the PEM. Furthermore, having the retention barrier in physical contact with the gas diffusion layer provides a continuous layer comprising continuous surfaces from the retention barrier to the PEM so that the hydrophobicity of these surfaces can play a role in keeping liquid water near the PEM or driving liquid water back to the PEM.

FIGS. 4(a)-(c) are diagrams illustrating various geometrical configurations for water retention barriers of the present invention. Examples on the left are substantially flat, sheet-like water retention barriers for use with fuel cells supplied with gaseous reactants. The retention barrier 70 is a microporous polymeric, metallic, ceramic, aerogel, or composite substrate having various thicknesses and being either hydrophobic or semihydrophobic. The other retention barriers 71,72 are non-porous polymeric, metallic, ceramic or composite substrates having various thickness. Retention barrier 71 is shown having a uniform distribution of through-holes and retention barrier 72 is shown having a non-uniform distribution of through-holes. The diameters and surface densities of the through-holes are selected based on whether the fuel cell is intended for operation at a low current density (i<200 mA cm⁻²), medium current density (200 mA cm⁻²<i<600 mA cm⁻²), or high current density (i>600 mA cm⁻²). For example, as the current density increases, the density of through holes and/or the diameters of the through holes may be increased. Especially where the barrier is not being used as a current collector, the holes are selected for water and reactant management without concern for electronic conductivity. If a retention barrier is made of a material that is not inherently hydrophobic, the barrier can be made hydrophobic or at least semihydrophobic by applying a layer or a film of hydrophobic material such as polytetrafluoroethylene, polyvinylidene fluoride or quasicrystals to at least one side of the substrate including the through-holes. The materials and configurations of the retention barriers 70,71,72 can be further modified, such as by providing barriers 70a,71a,72a with grooves or providing barriers 70b,71b,72b that are corrugated, respectively.

It is highly preferred, but not necessary, that the barrier extend over the entire active area of the cell. However, the barrier is beneficial wherever drying may be a problem. While the pores or holes are preferably sized so that water vapor can pass through the retention barrier for withdrawal from the stack to prevent flooding of the cathode, the barrier prevents excessive evaporative water loss that can be caused by excessive gas flow rates over the surface of the barrier. High gas flow rates may be desirable during operation of the monopolar fuel cell stack, for example to: (1) provide a volume of a reactant that is some multiple of the stoichiometric requirements, (2) provide cooling of the cell, (3) tolerate fluctuating flow rates caused by ambient conditions that are not directly controlled, (4) flush inerts, such as nitrogen, from the cell, or (5) remove undesirable reaction products from the cell. In accordance with the invention, the retention barrier enables a fuel cell to enjoy the benefits of high gas flow rates without suffering from excessive evaporative water losses or, on the other hand, flooding. Both drying of the membrane and flooding of the electrodes can significantly hamper the performance of the stack. Rather, the barrier retains sufficient water in the cathode so that back diffusion toward the anode is generally sufficient to maintain appropriate hydration of the PEM, even over a wide range of oxidant flow rates, stack temperatures, and other operating variables.

Accordingly, the invention also includes a method of operating a monopolar fuel cell (or monopolar fuel cell stack) that has a water retention barrier between the cathode gas diffusion layer and the oxidant source, the method including controlling the flow of oxidant over or through the fuel cell (or fuel cell stack) in order to maintain adequate hydration of the PEM. Higher flow rates of the oxidant may cool the fuel cell (or fuel cell stack) and prevent excessive evaporation of water in the cathode, resulting in reduced water losses in the form of water vapor through the water retention barrier. Conversely, lower flow rates of the oxidant may allow the fuel cell (or fuel cell stack) to operate at higher temperatures and cause additional evaporation of water in the cathode, resulting in removal of greater amounts of water from the cathode as water vapor passing through the water retention barrier. Accordingly, the temperature of the fuel cell (or fuel cell stack), and hence the water balance in the fuel cell (or fuel cell stack), can be managed by controlling the oxidant flow rate. In order to monitor or automate this process, cell resistance or impedance may be used as a measure of proper PEM hydration, wherein higher cell resistance indicates membrane drying. On the other hand, electrical current output from the fuel cell (or fuel cell stack) may be used as a measure of flooding. Specifically, a fan or blower can force air flow over the barrier, as needed, under the control of a digital or analog controller or computer that receives electronic signals representative of one or more fuel cell operating parameters indicative of membrane drying, such as the electronic resistance of one or more cells.

FIGS. 5(a)-(g) are schematic cross-sectional side views of various configurations of gas diffusion layers 110 suitable for incorporation in the fuel cells 10,50,60 of the types shown in FIGS. 1, 2 and 3. FIGS. 5(a), 5(b), and 5(c) show gas diffusion layers 110 incorporating a fluid permeable current collector 112 and a water retention barrier 114 as two separate elements that are placed side-by-side or attached to each other, where at least the fluid permeable current collector element 112 is electronically conducting. FIG.5(d) shows a gas diffusion layer 110 where the current collector 116 has voids that are impregnated or otherwise treated with a material that causes the collector 116, such as an expanded metal sheet, to also function as a water retention barrier. FIGS. 5(e), 5(f), and 5(g) show gas diffusion layers 110 having an electronically conducting element 118, such as a thin metal sheet with through-holes, that both collects current and retains water.

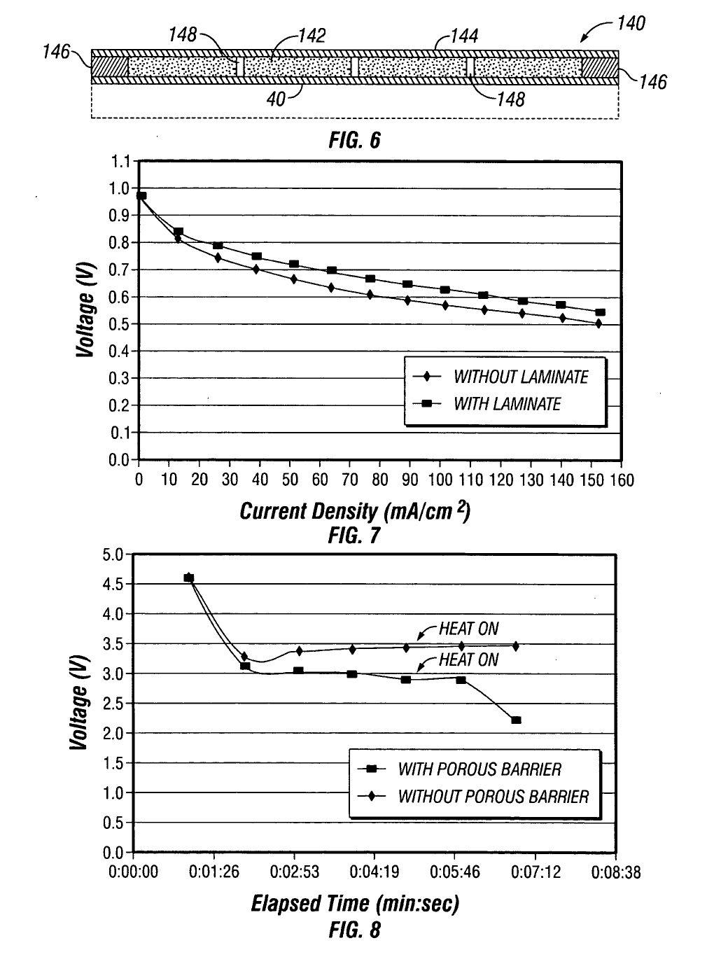

FIG. 6 is a cross-sectional side view of a subassembly 140 that includes a water retention barrier 40, an air filtration layer 142 and an optional macroporous structural support member 144. Preferably, the subassembly further includes one or more frames 146 or spacers 148 that provides the water retention barrier with additional support from member 144 and avoids excessive compression of the air filtration layer 142. The subassembly 140 is used adjacent an electrode with the water retention barrier 40 disposed against the electrode. For example, the subassembly 140 may be disposed against and cover the cathodic gas diffusion layer of a monopolar fuel cell 12 in the same manner as the water retention barrier 40 shown in FIG. 1(b).

The water retention barrier of the subassembly may be made from any of the materials previously described, such as: (i) a thin, gas permeable, liquid water impermeable membrane; (ii) a thin, porous sheet of material; or (iii) a thin, substantially solid sheet of material except for a plurality of small through-holes that penetrate through the sheet. These barriers may be treated or untreated as described previously.

The air filtration layer of the subassembly maybe made from any materials known or suitable for filtering air. The primary purpose of filtering the air is to remove airborne particulate material before it can damage the operation of the cathode through such mechanisms as poisoning, physical blockage of pores in the water retention barrier or gas diffusion structure, or reducing the oxidant concentration. For example, the air filtration layer may be made from activated carbon, carbon fibers, carbon powder or carbon granules, single-walled or multi-walled carbon nanotubes, buckminsterfullerenes or “buckyballs” such as C₆₀, small particles of metal oxides (such as magnesium oxide or calcium oxide), or combinations thereof. The fibers, powders, granules, nanotubes, and particles of various materials may be mixed together in optimum ratios for a particular fuel cell application and may be held or bonded together by a cured polymeric binding agent. Optionally, the individual components, or mixtures of them may be impregnated into, or supported on macroporous carbon cloth or carbon felt, polymer cloth, polymer felt, or polymer foam having open cells. While the “filtration layer” preferably will physically trap particles, the material forming the layer may perform other functions, either alone or in combination with particulate filtration, such as adsorption or catalytic destruction of contaminants or other components other than the desired oxidant.

The filtration layer may be formed in a manner that performs the function of chemical or microorganism abatement or destruction. The performance of a fuel cell (or fuel cell stack) may be improved or maintained by removing or destroying one or more chemicals or microorganisms that the fuel cell is exposed to. For instance, the air available to an air cathode may contain volatile organic compounds (VOCs), gaseous inorganic compounds (such as hydrogen sulfide), a range of combustion exhaust gases (such as from an internal combustion engine, diesel engine, or fuel reformer), ozone gas (especially at high altitudes), bacteria, viruses, fungus and the like. The detrimental effects that these components can have on cell performance have gone largely unrecognized, because of the closely controlled conditions of many fuel cell studies and the short duration of operation. Catalysts suitable for many of these functions are described in U.S. Pat. Nos. 5,997,831; 6,190,627; 6,214,303; 6,375,905; 6,569,393; and 6,616,903, which patents are incorporated by reference herein.

Specifically, prolonged exposure of a fuel cell (or fuel cell stack) to air containing high levels of ozone may result in oxidation of carbon-containing structures in the gas diffusion layer or electrocatalyst support layer. Accordingly, the air contacting structures of the cell, such as the gas diffusion layer or air filtration layer, may include an ozone destruction catalyst, such as manganese dioxide, derivatives of manganese dioxide, carbon, and palladium or platinum supported on carbon. Alternatively, ozone adsorbents such as zeolites may be used.

Carbon monoxide gas (CO) in the air can also be potentially harmful to long term fuel cell performance, in particular under low operating temperatures, e.g. less than 30° C., or more importantly less than 10° C. under fuel cell start-up conditions. Under these low temperatures, CO readily adsorbs on active catalyst sites of the cathode electrocatalyst hindering adsorption of oxygen from the air on such sites, thus slowing the rate of oxidative removal of CO as a result of oxidation of CO to CO₂. Therefore, it may be beneficial to include a CO oxidation catalyst that, in the presence of air or oxygen gas, converts the carbon monoxide to carbon dioxide (CO₂). Exemplary catalysts include gold catalysts supported on metal oxide particles, such as high surface area titanium dioxide powder or tin dioxide powder. Suitable metal oxide-supported catalysts may be prepared by methods selected from co-precipitation, deposition-precipitation, and suspension spray reaction. While these catalysts are operable at cold temperatures, their higher performance at warm temperatures can be conveniently achieved in the air filtration layer due to the increase in the fuel cell temperature experienced during operation. Exemplary catalysts are described in U.S. Pat. Nos. 6,616,903.

The catalysts of the air filtration layer may themselves be protected against atmospheric contaminants by coating them with a porous protective material, such as an adsorbent. A hydrophobic material may be further applied over, or mixed with, the protective material to protect the catalyst from liquid water.

Organophosphorous compounds undergo destructive adsorption on magnesium oxide (MgO), wherein the phosphorus atoms become immobilized as a strongly bound residue. To be effective, adsorptive reagents must generally be finely divided, such as nanoparticles. Also, because the reactions of adsorptive reagents are non-catalytic, the reagents must be periodically replaced to remain effective. The preferred reagents are composites comprising finely divided particles of a first metal oxide selected from MgO, CaO, Al₂O₃, SnO₂, TiO₂ and mixtures thereof, these particles being at least partially coated with a second metal oxide selected from Fe₂O₃, Cu₂O, NiO, CoO and mixtures thereof. These composites most preferably comprise between 90 and 99 percent of the first metal oxide. These same adsorptive reagents may also be used to scavenge H₂S and/or CO₂ from the air or fuel streams to the fuel cell. Metal oxide or metal hydroxide adsorbents may be used alone or in combination, such as those adsorbents selected from MgO, CeO₂, CaO, TiO₂, ZrO₂, FeO, V₂O₅, V₂O₃, Mn₂O₃, Fe₂O₃, CuO, NiO, ZnO VAl₂O₃, SnO₂, Ag₂O, SrO, BaO, Mg(OH)₂, Ca(OH)₂, Al(OH)₃, Sr(OH)₂, Ba(OH)₂, Fe(OH)₃, Cu(OH)₃, Ni(OH)₂, Co(OH)₂, Zn(OH)₂, and AgOH. Most preferably, these adsorbents are powders prepared by aerogel techniques. Optionally, the adsorbents may have reactive atoms (such as chlorine, bromine or iodine) stabilized on their surfaces, species adsorbed on their surfaces, or coated with a second metal oxide.

Iron oxide magnesium oxide-composites are examples of finely divided composite materials that may be included in the air filtration layer in order to destroy chlorinated hydrocarbons (chlorocarbons) and chlorofluorocarbons. Preferably, the composites comprise a first metal oxide, such as MgO, coated with a thin layer of a transition metal oxide, such as Fe₂O₃. Materials and applications such as these are described in U.S. Pat. No. 5,712,219, which is incorporated by reference herein.

A fuel cell (or fuel cell stack) under prolonged or cyclic operation can experience microorganism contamination or fouling. Biofouling or biofilm formation is likely to be a problem for fuel cells using air (or enriched air) as an oxidant and that operate at temperatures in the range of 5° C. to 85° C., preferably 10° C. to 65° C., or more preferably 20° C. to 50° C., i.e., at temperatures close to physiological temperature 37° C. Accordingly, the microorganism affected surfaces of the fuel cell, in particular an air filtration layer if present, and/or the cathode gas diffusion layer, may be coated with an adsorbent, such as MgO, CaO, Al₂O₃, ZrO₂, TiO₂, FeO, V₂O₅, V₂O₃, Mn₂O₃, Fe₂O₃, CuO, NiO, ZnO and mixtures thereof, wherein the adsorbent contains halogens, alkali metals or ozone. Microorganisms such as Bacillus Cereus, Bacillus Globigii, Chlamydia, Rickettsiae, fungi and viruses can be destroyed by contact with these adsorbents. Other chemical and biological agents may be similarly destroyed. Many of the materials and applications disclosed above are also described in U.S. Pat. Nos. 5,914,436; 5,990,373; 6,417,423; 6,653,519; 6,740,141; and 6,843,919, which patents are incorporated by reference herein.

Still further, the filtration layer and/or the water retention barrier may further remove or reduce the concentration of nitrogen that otherwise enters the cathode along with the oxygen.

It is preferred that the subassembly include a structural support member. A most preferred structural support member enables the subassembly to be integrated into a single composite article that is easy to handle. The structural support may take a number of forms and positions within the subassembly, but is preferably a rigid, macroporous structure disposed on the side of the subassembly that will face the air or oxidant stream. By disposing the structural support member to face the air supply, the support member can serve the additional function of providing the subassembly, and perhaps even the cell itself, with protection from physical impact or compression.

### EXAMPLE 1

Two identical five-cell, monopolar fuel cell stacks, similar to that shown in FIG. 3(a), were fabricated. Each stack was constructed with identical components including Nafion® 112 membranes as the PEM electrolyte, Pt black for both the anode and cathode electrocatalysts, and a reactively cured gas diffusion layer applied to a gold plated expanded titanium grid current collector for both the anode and cathode. One of the fuel cell stacks was modified with the addition of a porous liquid water retention barrier covering the entire five-cell cathode surface, similar to that shown in FIG. 3(b). The barrier was secured to the fuel cell along the entire perimeter of the stack to prevent any entry of reactants or exit of products from bypassing the barrier. The barrier used was electronically insulating (electronically non-conducting) and consisted of a sheet of expanded polytetrafluoroethylene (PTFE). The pore size of the barrier was between 35 and 50 nanometers. The sheet was attached to the stack to cover the entire cathode face. The anode plenums of the stacks were connected to a cylinder of hydrogen gas as a fuel supply. The fuel was supplied directly to the stack with no external humidification. Air was supplied to the cathodes by free convection from the surrounding atmosphere.

The two monopolar fuel cell stacks were operated in this configuration until their performances had stabilized. The average cell potential was recorded for each stack as a function of current density. The results are plotted as the i-V, or polarization, curves shown in FIG. 7. The stack equipped with the porous liquid water retention barrier shows consistently better performance (as exemplified by a higher potential) at all current densities. The improvement is sufficient to increase the current density at constant potential by an average of about 50%. This result demonstrates that reduced evaporation of water resulting from use of the porous barrier improves hydration and improves proton conductivity of the proton exchange membrane.

### EXAMPLE 2

The two monopolar fuel cell stacks described in Example 1 were operated as described there. After an initial warming up period, both stacks were held at a constant 1.5 Amps of current. The ambient room temperature was about 25° C. After about three hours the ambient temperature was raised from 25 to 42° C. Initially the performance of both stacks was stable, but eventually the performance of the stack without the porous liquid water retention barrier began to decline, as the proton exchange membrane began to dry out. The performance of the stack with the porous liquid water retention barrier remained steady, as shown in FIG. 8.

### EXAMPLE 3

While the monopolar fuel cell stacks described in Example 1 were operating at 25° C., all of the liquid water found in the exiting fuel stream was collected. This was used as a gauge of the amount of water returned from the cathode to the anode as a result of back diffusion though the proton exchange membrane solid polymer electrolyte. It was observed that the stack with the added porous barrier produced substantially more liquid water at the anode. This further demonstrates the effectiveness of the barrier for retaining water within the cell.

The terms “comprising,” “including,” and “having,” as used in the claims and specification herein, shall be considered as indicating an open group that may include other elements not specified. The term “consisting essentially of,” as used in the claims and specification herein, shall be considered as indicating a partially open group that may include other elements not specified, so long as those other elements do not materially alter the basic and novel characteristics of the claimed invention. The terms “a,” “an,” and the singular forms of words shall be taken to include the plural form of the same words, such that the terms mean that one or more of something is provided. For example, the phrase “a solution comprising a phosphorus-containing compound” should be read to describe a solution having one or more phosphorus-containing compound. The terms “at least one” and “one or more” are used interchangeably. The term “one” or “single” shall be used to indicate that one and only one of something is intended. Similarly, other specific integer values, such as “two,” are used when a specific number of things is intended. The terms “preferably,” “preferred,” “prefer,” “optionally,” “may,” and similar terms are used to indicate that an item, condition or step being referred to is an optional (not required) feature of the invention.

It should be understood from the foregoing description that various modifications and changes may be made in the preferred embodiments of the present invention without departing from its true spirit. The foregoing description is provided for purposes of illustration only and should not be construed in a limiting sense. Only the language of the following claims should limit the scope of this invention.

The following is a listing that describes various embodiments of the invention, most of which have been previously described, and form part of the detailed description.
1. A monopolar fuel cell stack comprising:
   a plurality of fuel cells placed spatially in a side-by-side arrangement forming at least one substantially planar array, each cell comprising an ion-conducting membrane with an anode and a cathode disposed on opposing sides of the membrane and a gas permeable, liquid water impermeable water retention barrier having a first face secured in intimate contact across the active area of the cathode and a second face exposed to ambient air conditions; and
   a substantially planar fluid permeable electronically conducting current collector providing electronic communication between the active area of the anode of a first fuel cell and the active area of the cathode of a second fuel cell adjacent the first fuel cell in the array.
2. The fuel cell stack of claim 1, wherein the water retention barrier is electronically non-conducting and extends across the cathodes of two or more of the plurality of fuel cells.
3. The fuel cell stack of claim 1, wherein the water retention barrier is secured along the edge of each of the plurality of fuel cells.
4. The fuel cell stack of claim 1, wherein the water retention barrier and the current collector are the same structure.
5. The fuel cell stack of claim 1, wherein the water retention barrier serves as a secondary current collector.
6. The fuel cell stack of claim 1, wherein the cathode comprises a gas diffusion layer, and wherein the water retention barrier is disposed within the gas diffusion layer.
7. The fuel cell stack of claim 1, wherein the water retention barrier has a face in full intimate contact with a gas diffusion layer of the cathode.
8. The fuel cell stack of claim 7, wherein the cathode gas diffusion layer is hydrophobic.
10. The fuel cell stack of claim 1, further comprising:
   a layer of a particulate and/or fibrous and/or nanotubular filter material disposed against the water retention barrier.
11. The fuel cell stack of claim 10, further comprising:
   a macroporous support member securing the layer of particulate and/or fibrous and/or nanotubular filter material against the water retention barrier.
12. The fuel cell stack of claim 1, wherein the water retention barrier is selected from a gas permeable, liquid water impermeable membrane, a porous sheet of material, a substantially solid sheet of material having a plurality of small through-holes that penetrate from one side of the sheet to an opposing side of the same sheet, or a combination thereof.
13. The fuel cell stack of claim 12, wherein the water retention barrier is a gas permeable, liquid water impermeable membrane.
14. The fuel cell stack of claim 13, wherein the water retention barrier has a thickness in the range of 0.1 microns to 20 microns.
15. The fuel cell stack of claim 13, wherein the water retention barrier is a free standing membrane or supported on a macroporous support.
16. The fuel cell stack of claim 13, wherein the water retention barrier is formed from a material selected from an organic polymer, a metal, a metal alloy, a ceramic, or a composite.
17. The fuel cell stack of claim 13, wherein the water retention barrier is hydrophobic.
18. The fuel cell stack of claim 13, wherein the water retention barrier has at least one surface that is hydrophobic.
19. The fuel cell stack of claim 1, further comprising a means for cooling the anode to a temperature that is less than the temperature of the cathode.
20. The fuel cell stack of claim 12, wherein the water retention barrier is a porous sheet of material.
21. The fuel cell stack of claim 20, wherein the porous sheet of material has a thickness in the range of 25 microns to 250 microns.
22. The fuel cell stack of claim 20, wherein the porous sheet of material is a free standing porous sheet or supported on a macroporous support.
23. The fuel cell stack of claim 20, wherein the porous sheet of material is formed from a material selected from an organic polymer, a metal, a metal alloy, a ceramic, or a composite.
24. The fuel cell stack of claim 20, wherein the porous sheet of material is hydrophobic.
25. The fuel cell stack of claim 20, wherein the porous sheet of material has at least one surface that is hydrophobic.
26. The fuel cell stack of claim 12, wherein the water retention barrier is a substantially solid sheet of material except for a plurality of small through-holes that penetrate from one side of the sheet to an opposing side of the same sheet.
27. The fuel cell stack of claim 26, wherein the substantially solid sheet has a thickness in the range of 25 microns to 250 microns.
28. The fuel cell stack of claim 26, wherein the substantially solid sheet is a free standing sheet or supported on a macroporous support.
29. The fuel cell stack of claim 26, wherein the substantially solid sheet is formed from a material selected from an organic polymer, a metal, a metal alloy, a ceramic, or a composite.
30. The fuel cell stack of claim 26, wherein the substantially solid sheet is hydrophobic.
31. The fuel cell stack of claim 26, wherein the substantially solid sheet has at least one surface that is hydrophobic.
32. The fuel cell stack of claim 1, further comprising a means for recovering water from the anode of each fuel cell.
33. The fuel cell stack of claim 32, wherein the water recovered from the anode of each fuel cell is recovered from a fuel gas stream after it exits the fuel cell stack.
34. The fuel cell stack of claim 1, further comprising:
   a source of a hydrogen-containing gas in fluid communication with the anode of each fuel cell.
35. The fuel cell stack of claim 1, further comprising:
   a source of a cathode reactant gas in fluid communication with the cathode of each fuel cell, wherein the cathode reactant gas is selected from air, oxygen, chlorine or bromine.
36. The fuel cell stack of claim 35, wherein the cathode reactant gas is ambient air provided at ambient pressure.
37. The fuel cell stack of claim 1, wherein the water retention barrier has a thickness between 0.1 and 300 micrometers.
38. The fuel cell stack of claim 1, wherein the porous water retention barrier has an average pore size between 20 and 500 nanometers.
39. The fuel cell stack of claim 1, wherein the porous water retention barrier has an average pore size between 30 and 200 nanometers.
40. The fuel cell stack of claim 1, wherein the water retention barrier includes a component selected from porous polymer sheet or film, expanded polymer sheet or film, filter paper, perforated polymer film, organic felts, and combinations thereof.
41. The fuel cell stack of claim 1, wherein the water retention barrier includes a material selected from porous thermoplastic sheet or film, expanded PTFE, polymer felt, non-halogenated thermoplastic, and combinations thereof.
42. The fuel cell stack of claim 1, wherein the water retention barrier includes a non-halogenated thermoplastic selected from polyethylene, polypropylene, polystyrene, polycyclo-pentadiene, nylons, and combinations thereof.
43. The fuel cell stack of claim 40, wherein the water retention barrier is a composite comprising a modifier selected from carbon powder, powdered metal, and combinations thereof.
44. The fuel cell stack of claim 43, wherein the composite is electronically conductive.
45. The fuel cell stack of claim 1, wherein the water retention barrier includes a halogenated thermoplastic selected from polytetrafluoroethylene (PTFE), polyvinylidene fluoride (PVDF), polyvinylflouride (PVF), polyvinylchloride (PVC), and combinations thereof.
46. The fuel cell stack of claim 45, wherein the water retention barrier is a composite comprising a modifier selected from carbon powder, powdered metal, and combinations thereof.
47. The fuel cell stack of claim 46, wherein the composite is electronically conductive.
48. The fuel cell stack of claim 1, wherein the water retention barrier includes a component selected from perforated metal sheet or foil, micro expanded metal sheet or foil, porous metal fritts, metal felts, and combinations thereof.
49. The fuel cell stack of claim 48, wherein the water retention barrier comprises a metal selected from titanium, aluminum, magnesium, copper, nickel, cobalt, tin, alloys thereof, and combinations thereof.
50. The fuel cell stack of claim 48, wherein the water retention barrier comprises a metal alloy selected from stainless steel, carbon steel, brass, aluminum alloys, magnesium alloys, and combinations thereof.
51. The fuel cell stack of claim 48, wherein the retention barrier comprises a porous metal that is plated or coated with a metal selected from nickel, tin, gold, silver, platinum, ruthenium, iridium, palladium, alloys thereof, and combinations thereof.
52. The fuel cell stack of claim 1, wherein the water retention barrier is a composite including a metal and an oxide.
53. The fuel cell stack of claim 1, wherein the water retention barrier is hydrophobic.
54. The fuel cell stack of claim 1, wherein the water retention barrier is electronically conducting.
55. The fuel cell stack of claim 1, wherein the water retention barrier is electronically insulating.
56. A method of operating a monopolar fuel cell stack comprising a plurality of fuel cells, each fuel cell having an anode and a cathode in contact with opposing faces of an ion conducting membrane, comprising:
   supplying hydrogen gas to the anode of each fuel cell;
   passing ambient air through a gas permeable, liquid water retention barrier covering the cathode of each fuel cell;
   withdrawing water vapor from the cathode through the liquid water retention barrier of each fuel cell;
   preventing the passage of liquid water through the liquid water retention barrier of each fuel cell; and
   allowing liquid water from each cathode to hydrate the membrane in each fuel cell.
57. The fuel cell stack of claim 56, wherein the air flow over each liquid water retention barrier is forced or convective.
58. The fuel cell stack of claim 56, further comprising:
   maintaining the anode of each fuel cell at a lower temperature than the cathode of each fuel cell.
59. The fuel cell stack of claim 56, further comprising:
   back diffusing liquid water from the cathode through the membrane to the anode of each fuel cell.
60. The fuel cell stack of claim 59, further comprising:
   removing liquid water from the anode of each fuel cell.
61. The fuel cell stack of claim 56, further comprising:
   removing water vapor from the fuel gas exiting the anode of each fuel cell.
62. The fuel cell stack of claim 61, wherein water vapor is removed from the fuel gas exiting the anode of each fuel cell by condensing the water as a liquid and separating it from the fuel gas.
63. The fuel cell stack of claim 61, wherein water vapor is condensed on a cooled surface in the vicinity of the anode of each fuel cell.
64. The fuel cell stack of claim 63, where the condensed water is removed from the vicinity of the anode of each fuel cell as a liquid.
65. The fuel cell stack of claim 63, wherein the cooled surface is treated to make it more hydrophilic.
66. The fuel cell stack of claim 56, wherein the ion conducting membrane is a polymer membrane electrolyte.
67. The fuel cell stack of claim 56, wherein the cathode reactant is air at ambient pressure.
68. The fuel cell stack of claim 67, wherein the air is provided through the liquid water retention barrier of each fuel cell without forced convection.
69. A subassembly for a monopolar fuel cell stack, comprising:
   a gas permeable, substantially liquid water impermeable barrier; and
   a layer of particulate filtration material coupled to the barrier.
70. The subassembly of claim 69, further comprising:
   a macroporous structural support member.
71. The subassembly of claim 70, further comprising:
   one or more frames or spacers providing the substantially liquid water impermeable barrier with additional support from the macroporous structural member and avoiding excessive compression of the air filtration layer.
72. The subassembly of claim 69, further comprising:
   a hydrophobic coating layer applied to the surface of the particulate filtration material exposed to unfiltered ambient air.
73. The subassembly of claim 69, further comprising:
   a thin porous sheet of a hydrophobic material placed over the surface of the particulate filtration material exposed to the unfiltered ambient air.
74. The subassembly of claim 73, wherein the thin porous sheet of hydrophobic material is held in place against the surface of the filtration material by a structural support member.
75. The subassembly of claim 69, further comprising chemical and/or microbiological abatement or destruction media.
76. The subassembly of claim 75, wherein the chemical and/or microbiological abatement or destruction media is downstream of the particulate filtration material.
77. The subassembly of claim 75, wherein the chemical and/or microbiological abatement or destruction media and the particulate filtration material comprise two separate and distinct layers.
80. The subassembly of claim 75, wherein the chemical and/or microbiological abatement or destruction media and the particulate filtration material comprise one homogeneous layer.
81. The subassembly of claim 69, wherein the particulate filtration material is bonded together by means of a polymeric binder.
82. The monopolar fuel cell stack of claim 1, wherein the cathode gas diffusion structure has a substantially uniform distribution of hydrophobic and hydrophilic pathways, and wherein the water retention barrier is disposed in contact with the cathode gas diffusion structure.

What is claimed is:

1. A monopolar fuel cell stack comprising:
a plurality of fuel cells placed spatially in a side-by-side arrangement forming at least one substantially planar array, each cell comprising an ion-conducting membrane with an anode and a cathode disposed on opposing sides of the membrane and a gas permeable, liquid water impermeable water retention barrier having a first face secured in intimate contact across the active area of the cathode and a second face exposed to ambient air conditions; and
a substantially planar fluid permeable electronically conducting current collector providing electronic communication between the active area of the anode of a first fuel cell and the active area of the cathode of a second fuel cell adjacent the first fuel cell in the array.

2. The fuel cell stack of claim 1, wherein the water retention barrier is electronically non-conducting and extends across the cathodes of two or more of the plurality of fuel cells.

3. The fuel cell stack of claim 1, wherein the water retention barrier is secured along the edge of each of the plurality of fuel cells.

4. The fuel cell stack of claim 1, wherein the water retention barrier and the current collector are the same structure.

5. The fuel cell stack of claim 1, wherein the water retention barrier serves as a secondary current collector.

6. The fuel cell stack of claim 1, wherein the cathode comprises a gas diffusion layer, and wherein the water retention barrier is disposed within the gas diffusion layer.

7. The fuel cell stack of claim 1, wherein the water retention barrier has a face in full intimate contact with a gas diffusion layer of the cathode.

8. The fuel cell stack of claim 7, wherein the water retention barrier is a gas permeable, liquid water impermeable membrane.

9. The fuel cell stack of claim 8, wherein the water retention barrier is hydrophobic.

10. The fuel cell stack of claim 1, further comprising a means for recovering water from the anode of each fuel cell.

11. The fuel cell stack of claim 1, wherein the porous water retention barrier has an average pore size between 20 and 500 nanometers.

12. The fuel cell stack of claim 1, wherein the water retention barrier includes a component selected from porous polymer sheet or film, expanded polymer sheet or film, filter paper, perforated polymer film, organic felts, and combinations thereof.

13. The fuel cell stack of claim 1, wherein the water retention barrier includes a material selected from porous thermoplastic sheet or film, expanded PTFE, polymer felt, non-halogenated thermoplastic, and combinations thereof.

14. The fuel cell stack of claim 1, wherein the water retention barrier includes a non-halogenated thermoplastic selected from polyethylene, polypropylene, polystyrene, polycyclo-pentadiene, nylons, and combinations thereof.

15. The fuel cell stack of claim 1, wherein the water retention barrier includes a component selected from perforated metal sheet or foil, micro expanded metal sheet or foil, porous metal fritts, metal felts, and combinations thereof.

16. A method of operating a monopolar fuel cell stack comprising a plurality of fuel cells, each fuel cell having an anode and a cathode in contact with opposing faces of an ion conducting membrane, comprising:
supplying hydrogen gas to the anode of each fuel cell;
passing ambient air through a gas permeable, liquid water retention barrier covering the cathode of each fuel cell;
withdrawing water vapor from the cathode through the liquid water retention barrier of each fuel cell;
preventing the passage of liquid water through the liquid water retention barrier of each fuel cell; and
allowing liquid water from each cathode to hydrate the membrane in each fuel cell.

17. The fuel cell stack of claim 16, further comprising:
maintaining the anode of each fuel cell at a lower temperature than the cathode of each fuel cell.

18. The fuel cell stack of claim 16, further comprising:
back diffusing liquid water from the cathode through the membrane to the anode of each fuel cell.

19. The fuel cell stack of claim 18, further comprising:
removing liquid water from the anode of each fuel cell.

20. A subassembly for a monopolar fuel cell stack, comprising:
a gas permeable, substantially liquid water impermeable barrier; and
a layer of particulate filtration material coupled to the barrier.

21. The subassembly of claim 20, further comprising:
a hydrophobic coating layer applied to the surface of the particulate filtration material exposed to unfiltered ambient air.

22. The subassembly of claim 20, further comprising chemical and/or microbiological abatement or destruction media.
